(19) United States
(12) Patent Application Publication
(10) Pub. No.: US 2021/0246315 A1
(43) Pub. Date: Aug. 12, 2021

(54) INORGANIC POLYMER CERAMIC-LIKE COATINGS AND METHODS FOR THEIR PREPARATION

(71) Applicants: MARYAM KAZEMZADEH DEHDASHTI, YPSILANTI, MI (US); AHMAD MADKOUR, CANTON, MI (US); JULIEN MARCHAL, ANN ARBOR, MI (US); REED SHICK, MIDLAND, MI (US)

(72) Inventors: MARYAM KAZEMZADEH DEHDASHTI, YPSILANTI, MI (US); AHMAD MADKOUR, CANTON, MI (US); JULIEN MARCHAL, ANN ARBOR, MI (US); REED SHICK, MIDLAND, MI (US)

(21) Appl. No.: 16/786,313

(22) Filed: Feb. 10, 2020

(51) Int. Cl. C09D 1/02; C09D 7/61; C09D 7/40

(52) U.S. Cl. CPC C09D 1/02; C09D 7/70; C09D 7/61

(57) ABSTRACT

An inorganic polymer coating. Low cost thermal barrier coatings thermal barrier coating and a process that starts with an aqueous suspension which may be sprayed, dipped, rolled or painted on a surface and cured. The cured thermal barrier coating has high thermal performance, low emissivity, high adhesion to multiple substrates, thermal cycle and thermal shock stability, high hardness, high elasticity and toughness.

### BACKGROUND OF THE INVENTION

Thermal barrier coatings (TBC) are very important to control the heat flow on surfaces on materials with a high thermal difference between a substrate and its surroundings. Ceramic thermal barrier coatings are used to reduce heat flow in many high value applications such as aerospace and race car exhaust systems. Typically, these ceramic coatings are plasma sprayed on the surfaces, which is a relatively expensive process. Solvent based spray-on ceramic coatings are commercially available; however, they suffer from low performance as a thermal barrier and are not robust with respect to temperature cycling, temperature shock and physical abrasion. The inventors herein have invented a low-cost thermal barrier coating (TBC) and process which starts with an aqueous suspension which may be sprayed, dipped, rolled or painted on a surface and cured. Optionally a topcoat may be added to the TBC. The cured TBC has high thermal performance, low emissivity, high adhesion to multiple substrates, thermal cycle and thermal shock stability, high hardness, high elasticity and toughness.

Surprisingly the inventors herein have developed a high-performance TBC which can be manufactured at large scale and low relative cost. This invention opens TBC to markets where it does not traditionally participate such as OEM automotive, industrial machinery, and photovoltaic cell protection.

In addition to the TBC properties of the ceramic coating, it also is suitable as a wear coating due to its surprising combination of high hardness, high adhesion, high elasticity and high toughness.

Furthermore, the ceramic coating demonstrates corrosion resistance when applied to metal substrates, despite the inherent porosity.

The inventors herein have developed a family of advanced inorganic composite polymer ceramic coatings which are capable of bonding to metals or other ceramics. These polymer materials can be euphonically described as thermoset ceramics. The material combines strength, hardness and high temperature performance of technical ceramics with the strength, ductility, thermal shock resistance, density, and easy processing of a polymer. The unique chemical structure of the polymer materials provide tailored thermal, adhesion, strength, hardness, toughness and wear properties.

The inventors herein have discovered a class of materials and methods to coat and cure parts to form a controlled porosity, thermal conduction, emissivity, surface hardness, flexibility, toughness, elongation, electrical conduction, density, and coefficient of thermal expansion (CTE).

Due to the highly tailorable nature of the ceramic materials' properties, its compatibility with functional additives, ease of fabrication, and high strength-to-weight ratio, there are many applications to which it can be applied. The ceramic formulations can be customized to provide coated system components that are not only application-tailored in their shape, but in their physiochemical properties as well. In addition to the ceramic's versatility in terms of manufacturing parts and components from the material itself, the material also has several applications for use in bonding applications. The chemical inertness and temperature resistance of the material to 3400° f allows it to be used to bond both nonferrous and ferrous metals and metal alloys as well as other ceramics and glass. Due to its high dimensional stability at high temperatures and low reactivity, the material can allow a disruptive innovation in allowing steel to be made non-corroding, low friction, low electrical and heat conduction. The tailorable thermal conductivity of the material is of especially great interest.

One reference regarding geopolymer coatings can be found at “Preparation of Metakaolin Based Geopolymer Coatings on Metal Substrates as Thermal Barriers”, Temuujin, Jadabaa; minijigmas, Amgalan; Richard, William; Lee, Melissa; Williams, Lestyn; van Riessen, Arie, Applied Clay Science 46 (2009) 265-270.

An additional reference discovered by the inventors herein include U.S. Pat. No. 9,725,809 that deals with ceramic coatings with scratch resistance and thermal conduction properties. The ceramic coating is intended to be applied on a metal support and in the form of a continuous film having a thickness between 2 and 100 μm.

This art teaches a ceramic coating on metal formed from oil containing precursors with high hardness additives; the hardness of the coating is not measured and is lower than 9 based on the description of the binder. The process of the instant invention provides oil free products, and the final coating has a Mohs hardness greater than 9.

GB1,497,659 deals with a thermal process of protecting at least a part of an element from flame or extreme thermal conditions comprising applying to a part of said element a protective composition comprising one or more components at least one of which has the property of undergoing an endothermic phase change from a solid to a vapor in a well-defined predetermined temperature range below the temperature of said flame or thermal extreme, the composition and proportions of each component being selected to form with the vapor at a temperature below the temperature of the flame or thermal extreme, a continuously porous open cell matrix through which the vapor passes to reach the ambient atmosphere.

This art has an intumescent coating on metal sprayed on in an initial slurry state with an added heat reflective topcoat added prior to curing the coating. This coating is different from the instant invention process and composition, in that, the instant composition is a ceramic heat resistant coating which is not intumescent but may include a top coat prior to cure.

U.S. Pat. No. 5,434,896 deals with wear resistant coatings for components of fuel assemblies and control assemblies, and, methods of enhancing wear resistance of fuel assembly and control assembly components using wear-resistant coatings.

This art includes the concepts of incorporating a ceramic layer on metal with a glass bonding agent. The ceramic coating provides wear resistance, and the glass binder is CTE matched to the metal. The instant invention includes a ceramic particle wear coating bonded to metal with an amorphous ceramic polymer.

U.S. patent publication 2006/0147734 deals with aqueous coating solutions and method for the treatment of a metal surface. Thus, what is disclosed is an aqueous coating solution for providing a corrosion resistant coating to a metal surface including: a water soluble silicate; and at least one metal ion (X) selected from those having a valence of less than or equal to +4; wherein said coating solution forms an aqueous silicate-X network such that the silicate remains soluble, and wherein on contact with a metal surface (Y) a coating comprised of silicate-X and Y is formed.

This art includes a water-soluble silicate which forms a corrosion resistant coating. This art differs from the instant invention in that in this art, the silicate remains soluble and in instant invention, the silicate forms an insoluble condensation reaction product which is corrosion resistant.

U.S. patent publication 2008/0093185 deals with ceramic-forming polymer materials. What is disclosed is a polymer material comprised of at least one non-cyclic ceramic-forming polymer. The porosity and elemental composition of the resulting ceramic can be varied by inclusion of polymers with particular ratios of carbon, silicon, oxygen, and hydrogen and by manipulation of the conditions under which the polymer material is converted to a ceramic. The resulting ceramic may be useful in fiber-reinforced ceramic matrix composites (CMCs), semiconductor fabrication, fiber coatings, friction materials, and fire-resistant coatings.

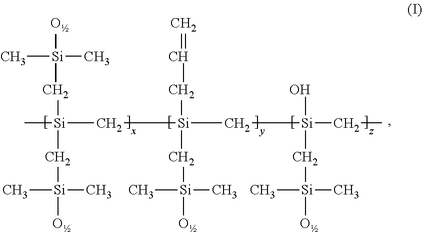

This art teaches the manufacture of ceramic friction materials (wear coatings) and fire-resistant coatings (thermal barrier) by pyrolizing organo-siloxane polymers. The process of the instant invention provides the coatings by a dissolution/condensation process which does not require sintering.

### THE INVENTION

The instant invention as disclosed herein is a method of producing an alkali aluminosilicate coating on a substrate. The method comprises providing a solubilized alkali silicate solution and a compound selected from the group consisting of aluminate and aluminosilicate.

Admixing the alkali silicate solution and compound and placing the admixed composition on a substrate as a coating and curing the admixture at two or more predetermined, distinct, temperatures such that the aluminate becomes at least partially solubilized and the alkali aluminosilicate condenses out of the admixture onto the substrate.

### DETAILED DESCRIPTION OF THE SPECIFICATION

The polymer material is processed as a reactive two-part material, similar to epoxy. The material as mixed can have a viscosity from 200 to 25,000 cPS. The lower viscosity is better for spraying thin films, while the higher viscosity is suitable as a rolled out thin sheet and applied directly. The spray techniques may include air spraying, airless spraying, electro spraying, rotary cone spraying, ultrasonic spraying.

The final cure reaction occurs when the substrate is exposed to temperatures of 160-250° F. for 2-24 hours. Longer curing times yield stronger materials. This cures the polymer to an advanced ceramic-like state. Shrinkage is in the range of less than 0.01%, allowing very fine tolerances. A molecularly smooth surface allows for low cost high performance, rapid, complex parts manufactured with excellent surface texture. The texture may be smooth and high gloss or may be made matt as desired. The advanced hybrid is a suitable alternative for critical and strategic coatings. The final cure may be between 250° C. and 450° C. Pigments many be added to the bulk of the coating or to the surface of the coating prior to curing.

These properties will allow the ceramic coating to fulfill several material needs, which include high temperature bonding or adhered structural component coating requirements that do not delaminate or crack, thermal barrier coatings to reduce heat flow to or from a substrate, wear coating, corrosion coatings or aesthetic coatings.

### EXAMPLES

Table 1 shows the comparison data sheet of various coatings. The substrates used were 409 SS plates.

The coating Example 1 is the alumina silicate base coat labeled TWR-228 with pigment topcoat labeled TCA5000.

Example 2 is a comparative example alumina silicate as in example 1 without the topcoat.

Example 3 is Cerakote W400Q with pigment topcoat TCA5000 and Example 4 is Cerakote C-7700 with pigment topcoat TCA5000. Comparative examples 5 and 6 are Cerakote W400Q and Cerakote C-7700 applied as per Cerakote directions. Cerakote W400Q and Cerakote C-7700 are two high temperature coatings.

The advantage of TWR-228/TCA5000 vs. the Cerakote coatings is significantly higher scratch hardness, higher Mohs hardness, higher abrasion resistance, higher reflectivity at temperatures up to 550° C., and providing corrosion resistance (tested on 1008 steel in 192 h aerated salt bath). On the other hand, Cerakote coatings provide more convenient curing conditions.

### Examples 1 and 2

Alumina silicate is (labeled TWR-228) is a mixture of premixed Part A consisting of Metastar 501HP, Maxfil 104 and spherical alumina and premixed part B consisting of water, KOH, Kasil 6, Borax, Sodium PMA and PolyDAMAC 20% formed in a slurry which was sprayed on the substrate with an air spray gun. The coating was cured in a 60 degrees C. oven for 8 hours at 30% relative humidity followed by a final cure at 300 C for 5 hours at ambient humidity.

Examples 2, 3, 4, and 5 were sprayed from the commercial spray can and cured as per the Table 1.

Examples 1, 2 and 3 topcoat TCA5000 process was to dry dust the uncured coating with a pigment from a dry media sprayer then the coating was cured as above.

Cerakote W400Q/TCA5000 and C-7700/TCA5000 are W400Q and C-7700 Cerakote coatings used as base coat with PetraForge TCA5000 as topcoat. These coatings combine the convenient curing process of Cerakote with higher reflectivity of the instant invention.

| | | | | | Example 3 | Example 4 | |
|---|---|---|---|---|---|---|---|
| | | Example 1 | Example 5 | Example 6 | Cerakote | Cerakote | |
| | | TWR-228/ | Cerakote | Cerakote | W400Q/ | C-7700/ | Example 2 |
| | | TCA5000 | W400Q | C-7700 | TCA5000 | TCA5000 | TWR-228 |
| 409SS surface treatment | | Sonication cleaning | Alumina blast | Alumina | Alumina | Alumina | Sonication |
| | | | | blast | blast | blast | cleaning |
| Topcoat | | Yes | No | No | Yes | Yes | No |
| Curing Conditions | Initial Cure | 30-60° C./ | air dry 30 | air dry 5 | air dry 30 | air dry 5 | 30-60° C./ |
| | | 3-24 h/ | minutes, | days | minutes, | days | 3-24 h/ |
| | | 20-70% RH | 80° C./20 min | | 80° C./20 min | | 20-70% RH |
| | Post Cure | 100-500° C./1- | 315° C., | None | 315° C., | None | 100-500° C./1- |
| | | 12 h/ambient | 60 minutes | | 60 minutes | | 12 h/ambient |
| | | humidity | | | | | humidity |

| | | | | | | |
|---|---|---|---|---|---|---|
| Specific Gravity of slurry (g/ml) | 2.41 ± 0.05 | 1.5 | 1.18 | 1.5 | 1.18 | 2.41 ± 0.05 |
| SEM Microstructure | No cracks | Many Medium to | No cracks | No cracks | No cracks | No cracks |
| | | large cracks | | | | |
| Cohesion - Scratch Hardness - Dip | 85 ± 10 | <1 | <1 | <1 | <1 | 85 ± 10 |
| Coating (MPa) | | | | | | |
| Hardness (Mohs) | 7 ± 0.5 | 2.5 ± 0.5 | 2.5 ± 0.5 | 2.5 ± 0.5 | 2.5 ± 0.5 | 6.5 ± 0.5 |
| Thickness - Spraying (um) | 140 ± 15 | 70 ± 5 | 12 ± 3 | 75 ± 5 | 17 ± 3 | 135 ± 15 |
| Adhesion - Bend Test (deg) | 28 ± 3 | no failure | no failure | no failure | no failure | 28 ± 3 |
| | | up to 40 | up to 40 | up to 40 | up to 40 | |
| Total Reflectivity (unpolished) | 0.70 ± 0.03 | 0.50 ± 0.03 | 0.55 ± 0.03 | 0.78 ± 0.03 | 0.80 ± 0.03 | 0.10 ± 0.03 |
| 400-550° C. | | | | | | |
| Max Operating Temp (° C.) | 550° C. | 550° C. | 550° C. | 550° C. | 550° C. | 1100° C. |
| Corrosion Inhibition (192 h) | Pass: corrosion is | Catastrophic | Failure: steel | Catastrophic | Failure: steel | Pass: |
| | completely inhibited | Failure: Corrosion | reacts under | Failure: Corrosion | reacts under | corrosion is |
| | | propagates and | the coating | propagates and | the coating | completely |
| | | cause complete | throughout | cause complete | throughout | inhibited |
| | | delamination | the whole | delamination | the whole | |
| | | of coating | sample | of coating | sample | |
| Taber Abrasion testing (cycles/mil) | 8100 ± 100 | 2700 ± 100 | Outside test | Outside test | Outside test | 8100 ± 100 |
| | | | lab - in | lab - in | lab - in | |
| | | | process | process | process | |

| | Part A | | | | | | | | | |
|---|---|---|---|---|---|---|---|---|---|---|
| | | | 30 um | Part B | | | | | | |
| | | | Panadyne | Poly | | | | | | |
| | Metastar | Maxfil | Spherical | DADMAC | | | | | | |
| | 501HP | 104 | Alumina | 20% | H2O | KOH | Kasil | Borax | | |
| Formula | (g) | (g) | (g) | (g) | (g) | (g) | 6 (g) | (g) | NaPMA | Total |
| TRW-288 | 2.33 | 0.54 | 20.18 | 0.02 | 7.55 | 7.83 | 59.08 | 2.17 | 0.30 | 100 |

What is claimed is:

1. Method of producing an alkali aluminosilicate coating on a substrate, said method comprising:
a. providing a solubilized alkali silicate solution;
b. providing a compound selected from the group consisting of
i. aluminate and,
ii. aluminosilicate;
c. admixing said alkali silicate solution and said compound and placing the admixed composition on a substrate as a coating;
d. curing said admixture at two or more predetermined, distinct temperatures such that said aluminate becomes at least partially solubilized and said alkali aluminosilicate condenses out of said admixture onto said substrate.

2. A method as claimed in claim 1 wherein said aluminate sources are solid components.

3. A method as claimed in claim 1 wherein said alkali aluminate sources are liquid components.

4. A method as claimed in claim 2 wherein said solid component includes a silicon source.

5. A method as claimed in claim 1 wherein the silicon to aluminum ratio is between 1:1 and 5:1.

6. A method as claimed in claim 2 wherein the silicon to aluminum ratio is between 1:1 and 5:1.

7. A method as claimed in claim 3 wherein the silicon to aluminum ratio is between 1:1 and 5:1.

8. A method as claimed in claim 1 wherein the silicon to aluminum ratio of the matrix is preferably between 1.5:1 and 2.5:1.

9. A method as claimed in claim 2 wherein the silicon to aluminum ratio of the matrix is preferably between 1.5:1 and 2.5:1.

10. A method as claimed in claim 3 wherein the silicon to aluminum ratio of the matrix is preferably between 1.5:1 and 2.5:1.

11. A method as claimed in claim 1 wherein the silicon to aluminum ratio of the entire compound is preferably between 1:3 and 2.5:1.

12. A method as claimed in claim 2 wherein the silicon to aluminum ratio of the entire compound is preferably between 1:3 and 2.5:1.

13. A method as claimed in claim 3 wherein the silicon to aluminum ratio of the entire compound is preferably between 1:3 and 2.5:1.

14. A method as claimed in claim 1 wherein the aluminum to alkali ratio of the matrix is between 1.2:1 to 0.8:1.

15. A method as claimed in claim 2 wherein the aluminum to alkali ratio of the matrix is between 1.2:1 to 0.8:1.

16. A method as claimed in claim 3 wherein the aluminum to alkali ratio of the matrix is between 1.2:1 to 0.8:1.

17. A method as claimed in claim 1 wherein, in addition, a filler is present.

18. A method as claimed in claim 2 wherein, in addition, a filler is present.

19. A method as claimed in claim 3 wherein, in addition, a filler is present.

20. A method as claimed in claim 1 wherein said filler is partially reactive.

21. A method as claimed in claim 2 wherein said filler is partially reactive.

22. A method as claimed in claim 3 wherein said filler is partially reactive.

23. A method as claimed in claim 17, wherein said filler is mullite.

24. A method as claimed in claim 17, wherein said filler is glass.

25. A method as claimed in claim 17, wherein said alkalinity is adjusted to prevent the dissolution of fillers.

26. A method as claimed in claim 17, wherein said filler is steel.

27. A method as claimed in claim 17 wherein said filler is selected from one or more of the group consisting of: aluminum oxide, titanium oxide, zirconium oxide, mullite, and Wollastonite.

28. A method as claimed in claim 17, wherein said filler is ceramic microspheres.

29. A method as claimed in claim 17 wherein said filler is selected from the group consisting of non-oxide ceramic, silicon carbide, boron nitride, boron carbide, titanium nitride.

30. A method as claimed in claim 1 wherein the humidity during cure is controlled between 5% to 95%.

31. A method as claimed in claim 1 wherein the initial cure is below 150° C. and the final cure is an additional step above 200° C.

32. A method as claimed in claim 1 wherein said substrate is selected from the group consisting of: metal, glass, ceramic, wood, PVA, and polyurethanes.

33. A substrate coated by the method as claimed in claim 1.

34. A coated substrate as claimed in claim 33 wherein the emissivity of the coating is below 0.4 at 0° C. to 550° C.

34. A coated substrate as claimed in claim 33 wherein the emissivity of the coating is below 0.7 at a temperature of from 800° C. to 1200° C.

35. A coated substrate as claimed in claim 33 wherein the coating has a thermal conductivity of 0.8 to 2 W/mK.

36. A coated substrate as claimed in claim 33 wherein the adhesion of the coating to said substrate is greater than 400 psi.

37. A coated substrate as claimed in claim 33 wherein said substrate will bend over a mandrel by more than 8 degrees for coating thicknesses of between 100 um and 300 um.

38. A coated substrate as claimed in claim 33 wherein the surface hardness is above Mohs 8.

39. A coated substrate as claimed in claim 33 wherein the surface scratch hardness is at least 250 Kpsi.

40. A coated substrate as claimed in claim 33 wherein said coating has an elasticity of at least 0.2%.

41. A coated substrate as claimed in claim 33 having an elongation to break of at least 2%.

42. A coated substrate as claimed in claim 33 wherein said coating having a CTE mismatch at 400° C. is less than the elasticity of said coating.

43. A coated substrate as claimed in claim 33 that is stable to UV radiation ASTM G154.

44. A coated substrate as claimed in claim 33 that is capable of passing GMW 14380 thermal shock test.

45. A coated substrate as claimed in claim 33 that is capable of passing gravelometery test ASTM D3170-03.

46. A coated substrate as claimed in claim 33 that is capable of passing a corrosion test equivalent to 200 h salt spray chamber.
